(19) United States
(12) Patent Application Publication
(10) Pub. No.: US 2012/0266205 A1
(43) Pub. Date: Oct. 18, 2012

(54) Electronic Device Having Connection Terminal

(75) Inventors: Keisuke Tsukamoto, Daito-shi (JP); Norihiro Higashi, Daito-shi (JP); Kensuke Kono, Daito-shi (JP); Kenji Okamoto, Daito-shi (JP)

(73) Assignee: Funai Electric Co., Ltd.

(21) Appl. No.: 13/442,219

(22) Filed: Apr. 9, 2012

(30) Foreign Application Priority Data
Apr. 14, 2011 (JP) 2011-090336

(51) Int. Cl. H04N 21/40

(52) U.S. Cl. 725/127

(57) ABSTRACT

A TV receiver as an electronic device is connected to an adjustment device by an exclusive cable of two transmission lines connected to an HDMI connection terminal. In adjustment mode, a main microcomputer of the TV receiver sends a signal to the adjustment device through a transmission line including an HPD line with an HPD port serving as an output port for the signal, and receives a signal from the adjustment device through a transmission line including a +5V line with a +5V port serving as an input port for the signal. Thus, the microcomputer can perform adjustment processes by receiving product information and various set values from the adjustment device to store them in a memory, and by sending the stored various values to the adjustment device, without providing a UART port, making it possible to reduce manufacturing cost.

### BACKGROUND OF THE INVENTION

1. Field of the Invention

The present invention relates to an electronic device having a connection terminal for connection with an external device.

2. Description of the Related Art

Conventionally, at the time of shipment of electrical home appliances from factory, various processes (hereafter “adjustment processes”) are often performed such as recording product information and adjusting various set values in the home appliances. Each home appliance has in advance a UART (Universal Asynchronous Receiver/Transmitter) port for adjustment processes performed by connecting the UART port to an adjustment device with a transmission cable.

### BRIEF SUMMARY OF THE INVENTION

Note that the UART port is an exclusive terminal for adjustment processes, and is not used by users after shipping the home appliances from factory. However, each home appliance is required to have a UART port for adjustment processes, causing a problem that the manufacturing cost of the home appliances cannot be reduced.

In the prior art, Japanese Registered Utility Model 3112392 discloses an HDTV (high-definition television) which receives information frames containing adjustment data from outside, and writes them to a register of an HDMI (High-Definition Multimedia Interface) receiver through a video signal input terminal, and allows a microcomputer to read the adjustment data in the register so as to control adjustment. However, this HDTV cannot output e.g. its product information, so that it is required to have a UART port for information output, making it unable to solve the problem described above. Further, Japanese Laid-open Patent Publication 2008-109219 discloses an EDID (Extended Display Identification Data) updating circuit which outputs a low-level voltage signal to a write-protect port through a GPIO (General Purpose Input/Output) port so as to bring an EDIDROM (Read-Only Memory) to a state in which it can update EDID, and updates the EDID in the EDIDROM by using EDID data input through a DDC (Data Display Channel) port of an HDMI connector. However, this EDID updating circuit also cannot output e.g. product information, and thus cannot solve the problem described above.

An object of the present invention is to provide an electronic device which can be subjected to adjustment processes at the time of shipment from factory and can reduce manufacturing cost.

According to the present invention, this object is achieved by an electronic device comprising: a connection terminal connected to transmission lines conforming to a given communication protocol; communication means for sending and receiving signals to and from an external device connected to the connection terminal; and control means having, as an operation mode, adjustment mode for performing an adjustment process for various parts of the electronic device. When the control means operates in the adjustment mode while the external device is connected to the connection terminal, the control means controls the sending and receiving of the signals by the communication means, using the transmission lines as a signal sending line and a signal receiving line for sending and receiving the signals to and from the external device.

Preferably, the given communication protocol is defined in the High-Definition Multimedia Interface standard.

Further preferably, one of the transmission lines is a voltage input line for inputting a voltage of a predetermined level to the electronic device, while another one is a line including a Hot Plug Detect line.

According to the present invention, when the electronic device operates in the adjustment mode while the external device is connected to the connection terminal, the transmission lines based on a given communication protocol are used as a signal sending line and a signal receiving line for sending and receiving signals to and from the external device. Thus, the electronic device can perform adjustment processes using the external device without providing a UART port provided in the prior art, making it possible to reduce manufacturing cost.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram of a TV receiver according to an embodiment of the present invention and an adjustment device connected to the TV receiver;

FIG. 2 is a schematic block diagram showing connection between a portion of the TV receiver and the adjustment device; and

FIG. 3 is a flow chart showing an adjustment process performed in the TV receiver.

### DETAILED DESCRIPTION OF THE INVENTION

Embodiments of the present invention, as best mode for carrying out the invention, will be described hereinafter with reference to the drawings. The present invention relates to an electronic device. It is to be understood that the embodiments described herein are not intended as limiting, or encompassing the entire scope of, the present invention. Note that like parts are designated by like reference numerals, characters or symbols throughout the drawings.

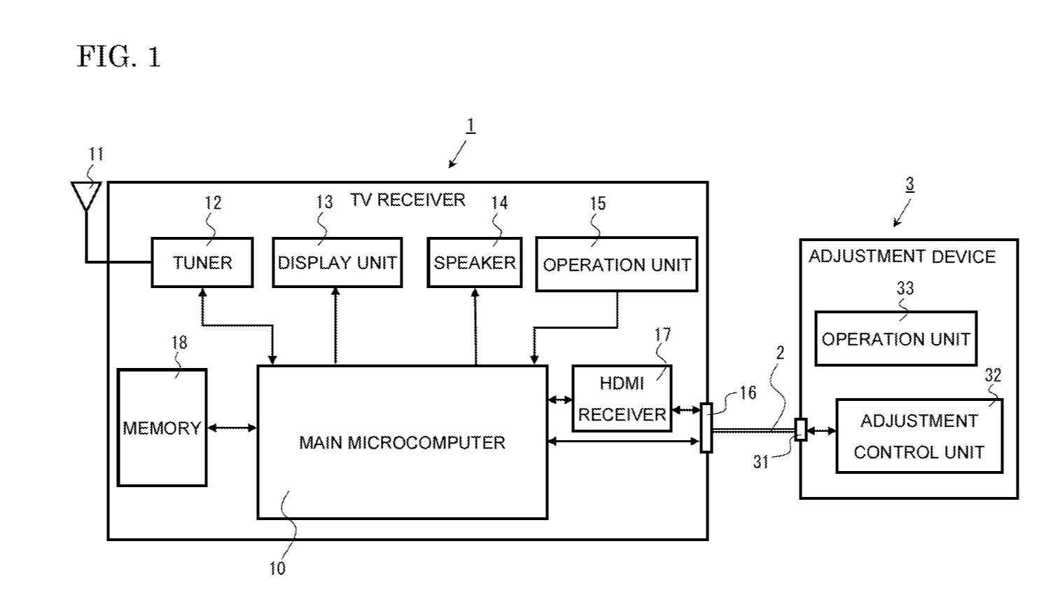

FIG. 1 is a schematic block diagram of a television (hereafter “TV”) receiver 1 as an electronic device according to an embodiment of the present invention which is connected to an adjustment device (claimed “external device”) 3. The adjustment device 3 serves to subject the TV receiver 1 to a series of processes (hereafter “adjustment processes”) such as recording product information and adjusting various set values at the time of shipment of the TV receiver 1 from factory. The adjustment device 3 comprises: a connection terminal 31 connected to an end of an exclusive cable 2; an adjustment control unit 32; and an operation unit 33 operated by an operator. The TV receiver 1 and the adjustment device 3 are connected to each other by connecting the other end of the exclusive cable 2 to the TV receiver 1.

The TV receiver 1 of the present embodiment comprises: a tuner 12 connected to an antenna 11 for receiving a television broadcast signal; a display unit 13 for displaying video; a speaker 14 for outputting audio; an operation unit 15 having a button operated by a user; an HDMI (High-Definition Multimedia Interface) connection terminal (claimed “connection terminal”) 16; an HDMI receiver 17; a memory 18 storing various information; and a main microcomputer (claimed “communication means” and “control means”) 10 for controlling various parts of the TV receiver 1. The TV receiver 1 is in accordance with HDMI. The tuner 12 receives a digital broadcast signal of each channel transmitted from a broadcast station through the antenna 11, and includes a decoder (not shown) to decode the received digital broadcast signal so as to output video and audio signals to the main microcomputer 10.

The display unit 13 displays video of a TV program received by the tuner 12 as well as video based on video stream input to the HDMI connection terminal 16. The speaker 14 outputs audio of the TV program received by the tuner 12 as well as audio based on the video stream input to the HDMI terminal 16. The HDMI connection terminal 16 is a terminal which is known to be connectable to an HDMI cable. If the HDMI connection terminal 16 is connected by an HDMI cable to, for example, a video audio player (not shown) as an external device, so as to connect the video audio player to the HDMI receiver 17, the HDMI receiver 17 receives video stream and audio stream input to the TMDS lines of the HDMI connection terminal 16 so as to output decoded video signals and audio signals to the main microcomputer 10. Here, instead of connecting the HDMI connection terminal 16 to an HDMI cable, the HDMI connection terminal 16 is connected to the other end of the exclusive cable 2, which in turn is connected to the adjustment device 3. As shown in TABLE 1 below, the HDMI connection terminal 16 has a connector of 19 (nineteen) pins (or ports) which are connected to respective transmission lines as required.

TABLE 1

| PIN | SIGNAL | PIN | SIGNAL |
|---|---|---|---|
| 1 | TMDS DATA 2+ | 2 | TMDS DATA 2 SHIELD |
| 3 | TMDS DATA 2− | 4 | TMDS DATA 1+ |
| 5 | TMDS DATA 1 SHIELD | 6 | TMDS DATA 1− |
| 7 | TMDS DATA 0+ | 8 | TMDS DATA 0 SHIELD |
| 9 | TMDS DATA 0− | 10 | TMDS CLOCK+ |
| 11 | TMDS CLOCK SHIELD | 12 | TMDS CLOCK− |
| 13 | CEC | 14 | RESERVE (NOT |
| | | | CONNECTED) |
| 15 | SCL | 16 | SDA |
| 17 | DDC/CEC GROUND | 18 | +5 V POWER SUPPLY |
| 19 | HOT PLUG | | |
| | DETECT (HPD) | | |

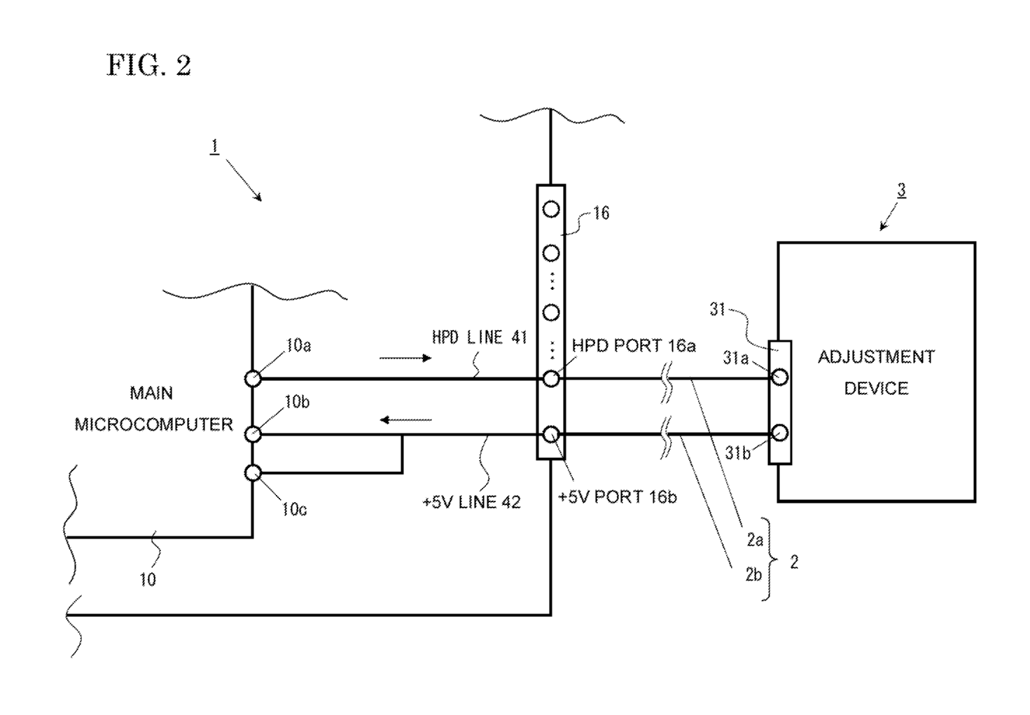

Connected to the 19 pins (ports) of the HDMI connection terminal 16 shown in TABLE 1 above are corresponding transmission lines such as: TMDS (Transition Minimized Differential Signaling) lines for transmitting video signals and/or audio signals; a CEC (Consumer Electronic Control) line for transmitting a CEC command interactively; a DDC (Display Data Channel) line for transmitting EDID (Extended Display Identification Data) data; an HPD (Hot Plug Detect) line 41 (refer to FIG. 2 below); and a +5V line 42 (refer to FIG. 2 below) for inputting a voltage of a predetermined level (here +5V) to the TV receiver 1. These transmission lines conform to a communication protocol (claimed “given communication protocol”) defined in the HDMI standard.

The memory 18 stores a program for operating the main microcomputer 10, product information of the TV receiver 1, and various set values such as brightness values of the display unit 13. The HDMI receiver 17, if connected by an HDMI cable to an external device such as a video audio player, communicates with such an external device through the HDMI cable by using a communication protocol defined in the HDMI standard. Based on the operation of the operation unit 15, the main microcomputer 10 controls the TV receiver 1. The main microcomputer 10 has operation modes including normal mode and adjustment mode for performing an adjustment process or processes for various parts of the TV receiver 1, in which the operation modes can be changed from one to another by operating the operation unit 15 or by receiving a command sent from the adjustment device 3. When operating in adjustment mode, the main microcomputer 10 sends and receives signals to and from the adjustment device 3 through the exclusive cable 2.

Next, referring to FIG. 2, the connection between the TV receiver 1 and the adjustment device 3 will be described. FIG. 2 is a schematic block diagram showing connection between the TV receiver 1 and the adjustment device 3. The exclusive cable 2 has two transmission lines 2a, 2b. An end of the transmission line 2a is connected to a connection port 31a of the connection terminal 31 of the adjustment device 3, while the other end of the transmission line 2a is connected to an HPD port (pin) 16a of the HDMI connection terminal 16. On the other hand, an end of the transmission line 2b is connected to a connection port 31b of the connection terminal 31 of the adjustment device 3, while the other end of the transmission line 2b is connected to a +5V port (pin) 16b of the HDMI connection terminal 16. The HPD line 41 is connected to the HPD port 16a, and is also connected to a GPIO port 10a of the main microcomputer 10 in the TV receiver 1. The +5V line 42 connected to the +5V port 16b is connected to GPIO ports 10b, 10c of the main microcomputer 10.

When operating in adjustment mode, the main microcomputer 10 sends a signal to the adjustment device 3 through the HPD line 41 and the transmission line 2a (which form claimed “transmission line”, “signal sending line” and “a line including a Hot Plug Detect line”), and receives a signal from the adjustment device 3 through the transmission line 2b and the +5V line 42 (which form claimed “transmission line”, “signal receiving line” and “voltage input line”). In other words, the HPD port 16a serves as an output port for sending a signal to the adjustment device 3, while the +5V port 16b serves as an input port for receiving a signal from the adjustment device 3. Thus, the microcomputer 10 can perform adjustment processes by receiving e.g. product information and various set values sent from the adjustment device 3 so as to store them in the memory 18, and by sending e.g. the various values stored in the memory 18 to the adjustment device 3. Note that for receiving the signal from the adjustment device 3 through the +5V line 42, the voltage of the GPIO port 10c of the main microcomputer 10 is made high (H) to recognize the connection of the exclusive line 2 so as to then allow receiving the signal sent from the adjustment device 3, or more specifically, to allow the main microcomputer 10 to receive, at the GPIO port 10b, the signal sent from the adjustment device 3.

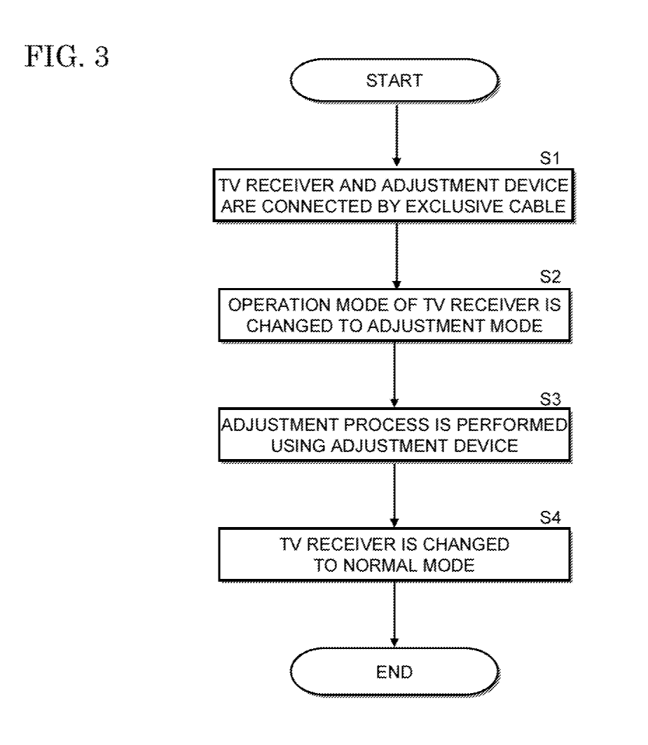

Now, referring to FIG. 3 which is a flow chart showing an adjustment process performed in the TV receiver 1, the adjustment process according to the present embodiment will be described. To start with, the TV receiver 1 and the adjustment device 3 are connected to each other by the exclusive cable 2 (S1), and then the operation mode of the main microcomputer 10 of the TV receiver 1 is changed to adjustment mode (S₂). The operation mode can be changed by an operator to operate the operation unit 15 or by allowing the adjustment device 3 to send the TV receiver 1a command signal to change the operation mode to the adjustment mode. Thereafter, an adjustment process for the TV receiver 1 is performed by the operator using the adjustment device 3 (S₃). After the adjustment process, the main microcomputer 10 of the TV receiver 1 is changed to normal mode (S4).

As described above, when the TV receiver 1 of the present embodiment operates in adjustment mode while the adjustment device 3 is connected to the HDMI connection terminal 16 through the exclusive cable 2, the main microcomputer 10 of the TV receiver 1 controls communication, or more specifically, controls the sending and receiving of signals thereby, using the HPD line 41 as a part of a signal sending line for sending a signal to the adjustment device 3, and using the +5V line 42 as a part of a signal receiving line for receiving a signal sent from the adjustment device 3. Thus, the TV receiver 1 can perform adjustment processes using the adjustment device 3 without providing a UART port provided in the prior art, making it possible to reduce manufacturing cost.

It is to be noted that the present invention is not limited to the above embodiment, and various modifications are possible within the spirit and scope of the present invention. For example, the above embodiment shows a TV receiver as an example of the electronic device according to the present invention. However, it can be any electronic device that has an HDMI connection terminal and can send and receive signals to and from an external device, such as an adjustment device, through transmission lines connected to the HDMI connection terminal.

In addition, in the above embodiment, when operating in adjustment mode, the main microcomputer 10 sends a signal to the adjustment device 3 through the HPD line 41 and the transmission line 2a, and receives a signal from the adjustment device 3 through the transmission line 2b and the +5V line 42. However, the main microcomputer 10 may send a signal to the adjustment device 3 through the transmission line 2b and the +5V line 42, and receive a signal from the adjustment device 3 through the HPD line 41 and the transmission line 2a.

Furthermore, although the above embodiment shows the use of an HPD line and a +5V line for communication, other transmission lines such as TMDS lines of the HDM connection terminal can be used instead.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2011-090336 filed Apr. 14, 2011, the content of which is hereby incorporated by reference.

1. An electronic device comprising:
a connection terminal connected to transmission lines conforming to a given communication protocol;
communication means for sending and receiving signals to and from an external device connected to the connection terminal; and
control means having, as an operation mode, adjustment mode for performing an adjustment process for various parts of the electronic device,
wherein when the control means operates in the adjustment mode while the external device is connected to the connection terminal, the control means controls the sending and receiving of the signals by the communication means, using the transmission lines as a signal sending line and a signal receiving line for sending and receiving the signals to and from the external device.

2. The electronic device according to claim 1,
wherein the given communication protocol is defined in the High-Definition Multimedia Interface standard.

3. The electronic device according to claim 2,
wherein one of the transmission lines is a voltage input line for inputting a voltage of a predetermined level to the electronic device, while another one is a line including a Hot Plug Detect line.
